(19) United States
(12) Patent Application Publication
(10) Pub. No.: US 2022/0286987 A1
(43) Pub. Date: Sep. 8, 2022

(54) TERMINAL

(71) Applicant: NTT DOCOMO, INC., Tokyo (JP)

(72) Inventors: Daisuke Kurita, Tokyo (JP); Hiroki Harada, Tokyo (JP); Satoshi Nagata, Tokyo (JP)

(73) Assignee: NTT DOCOMO, INC., Tokyo (JP)

(21) Appl. No.: 17/630,373

(22) PCT Filed: Jul. 30, 2019
(86) PCT No.: PCT/JP2019/029886

§ 371 Date: Jan. 26, 2022

(51) Int. Cl. H04W 56/00

(52) U.S. Cl. CPC H04W 56/0015; H04W 16/28

(57) ABSTRACT

A terminal receives a plurality of SSBs in a frequency band including one frequency range or a plurality of frequency ranges and a different frequency band different from the frequency band. The SSBs are divided into a plurality of synchronization signal groups. The terminal receives the synchronization signal groups transmitted according to a periodicity shorter than a defined transmission periodicity.

### TECHNICAL FIELD

The present invention relates to a terminal that performs radio communication, and particularly relates to a terminal that receives synchronization signal blocks (SSBs).

### BACKGROUND ART

The 3rd Generation Partnership Project (3GPP) specifies Long Term Evolution (LTE), and with the aim of further speeding, specifies LTE-Advanced (hereinbelow, the LTE includes the LTE-Advanced). Further, specifications for 5th generation mobile communication system (5G, also called as New Radio (NR) or Next Generation (NG)) are also being considered.

In Release 15 and Release 16 (NR) of the 3GPP, an operation in a band including FR1 (410 MHz to 7.125 GHz) and FR2 (24.25 GHz to 52.6 GHz) is specified. In the specifications of Release 16 and subsequent releases, an operation in a band exceeding 52.6 GHz is also considered (Non-Patent Document 1). A target frequency range in Study Item (SI) is between 52.6 GHz and 114.25 GHz.

When the carrier frequency is considerably high as in this case, increase in phase noise and propagation loss becomes a problem. Further, it is more sensitive to the peak-to-average power ratio (PAPR) and the power amplifier nonlinearity.

In the NR, initial access, cell detection, and reception quality measurement are performed using SSBs (SS/PBCH Blocks) each composed of SSs (Synchronization Signals) and a downlink PBCH (Physical Broadcast CHannel) (Non-Patent Document 2). The transmission periodicity of the SSBs can be set in a range of 5, 10, 20, 40, 80, and 160 milliseconds for each cell (a transmission periodicity of 20 milliseconds is assumed for an initial access terminal (User Equipment, UE)).

Transmission of SSBs in a time of the transmission periodicity is limited to within 5 milliseconds (a half frame) and the SSBs can be associated with different beams, respectively. In Release 15, the number of SSB indices is 64 (indices 0 to 63).

### PRIOR ART DOCUMENT

### Non-Patent Document

Non-Patent Document 1: 3GPP TR 38.807 V0.1.0, 3rd Generation Partnership Project; Technical Specification Group Radio Access Network; Study on requirements for NR beyond 52.6 GHz (Release 16), 3GPP, March 2019
Non-Patent Document 2: 3GPP TS 38.133 V15.5.0, 3rd Generation Partnership Project; Technical Specification Group Radio Access Network; NR; Requirements for support of radio resource management (Release 15), 3GPP, March 2019

### SUMMARY OF THE INVENTION

When a different frequency band different from FR1/FR2, such as a high frequency band exceeding 52.6 GHz as explained above is used, a narrower beam needs to be generated using a massive antenna that has many antenna elements to handle a wide bandwidth and large propagation loss. That is, many beams are required to cover a certain geographical area.

Therefore, if a time-division multiplexing (TDM) beam sweeping method that can handle analog beam forming as defined in Release 15 is applied to SSBs as it is, there are the following problems. These problems are particularly noticeable when the number of SSBs is increased (for example, to 256).

Specifically, there is a possibility that efficient transmission of SSBs is limited and that overhead relating to SSB signaling is increased. There is also a possibility that beams to be used for data transmission are also restricted by beam sweeping for the SSB transmission and data scheduling delay for a terminal is elongated.

An occasion for a procedure of random access (RA) mapped with SSB indices, specifically, a physical random access channel (PRACH) occasion (PRACH Occasion (RO)) also has problems similar to those of the SSBs.

Therefore, the present invention has been made in view of such circumstances, and one object of the present invention is to provide a terminal capable of avoiding data scheduling delay even in a case in which a different frequency band different from FR1/FR2 is used.

According to one aspect of the present disclosure a terminal (UE 200) includes a receiving unit (radio signal transmitting and receiving unit 210) that receives a plurality of synchronization signal blocks (SSB) in a frequency band including one frequency range or a plurality of frequency ranges (FR1 and FR2) and a different frequency band different from the frequency band (e.g., FR4). The synchronization signal blocks are divided into a plurality of synchronization signal groups, and the receiving unit receives the synchronization signal groups transmitted according to a periodicity shorter than a defined transmission periodicity.

### BRIEF DESCRIPTION OF DRAWINGS

FIG. 1 is an overall schematic configuration diagram of a radio communication system 10.

FIG. 2 is a diagram illustrating frequency ranges used in the radio communication system 10.

FIG. 3 is a diagram illustrating a configuration example of a radio frame, subframes, and slots used in the radio communication system 10.

FIG. 4 is a functional block diagram of a UE 200.

FIG. 5 is a diagram illustrating a conventional setting example of SSBs.

FIG. 6 is a diagram illustrating a conventional setting example of RACH.

FIG. 7 is a diagram illustrating a conventional setting example of SSBs and ROs.

FIG. 8 is a diagram illustrating a schematic image of arrangement of an SSB according to the present embodiment.

FIG. 9 is a diagram illustrating a setting image of an SMTC according to the present embodiment.

FIG. 10 is a diagram illustrating a setting image of an MG according the present embodiment.

FIG. 11 is a diagram illustrating a setting example of synchronization signal groups (G_{SSB}) according to the present embodiment.

FIG. 12 is a diagram illustrating a setting example of the SMTC according to the present embodiment.

FIG. 13 is a diagram illustrating an example of an antenna beam reception status in which SSB detection and measurement using all SMTC sub windows are triggered.

FIG. 14 is a diagram illustrating a setting example of the MG according to the present embodiment.

FIG. 15 is a diagram illustrating an example of a hardware configuration of the UE 200.

### MODES FOR CARRYING OUT THE INVENTION

### (1) Overall Schematic Configuration of Radio Communication System

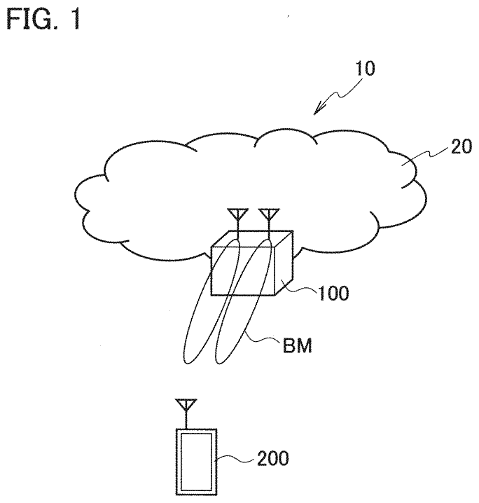

FIG. 1 is an overall schematic configuration diagram of a radio communication system 10 according to the present embodiment. The radio communication system 10 is a radio communication system according to 5G New Radio (NR). The radio communication system 10 includes Next Generation-Radio Access Network 20 (hereinafter, “NG-RAN 20”) and a terminal 200 (hereinafter, “UE 200”, “User Equipment”, “UE”).

The NG-RAN 20 includes a radio base station 100 (hereinafter, “gNB 100”). A concrete configuration of the radio communication system 10, including the number of the gNBs and the UEs, is not limited to the example shown in FIG. 1.

The NG-RAN 20 actually includes a plurality of NG-RAN Nodes, in particular, the gNBs (or ng-eNB). Also, the NG-RAN 20 is connected to a core network (5GC, not shown) according to the 5G. The NG-RAN 20 and the 5GC may be simply expressed as “network”.

The gNB 100 is a radio base station according to the 5G. The gNB 100 performs a radio communication with the UE 200 according to the 5G. The gNB 100 and the UE 200 can handle, by controlling a radio signal transmitted from a plurality of antenna elements, Massive MIMO (Multiple-Input Multiple-Output) that generates a beam BM with a higher directivity, carrier aggregation (CA) that bundles a plurality of component carriers (CC) to use, dual connectivity (DC) in which communication is performed simultaneously between two NG-RAN Nodes and the UE, and the like.

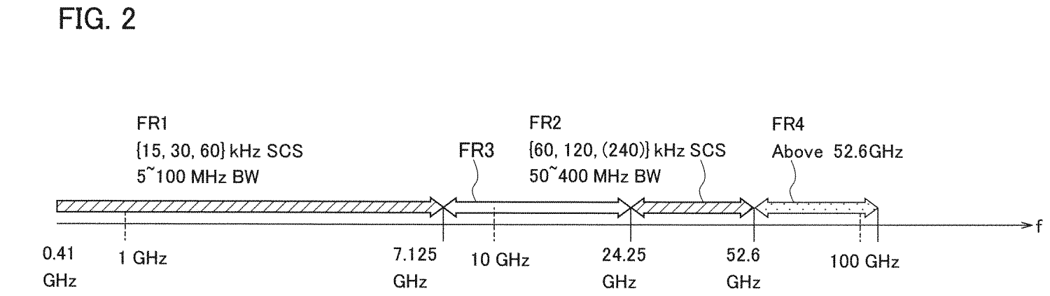

The radio communication system 10 corresponds to a plurality of frequency ranges (FR). FIG. 2 illustrates frequency ranges used in the radio communication system 10.

As shown in FIG. 2, the radio communication system 10 corresponds to FR1 and FR2. The frequency band of each FR is as below.

FR1: 410 MHz to 7.125 GHz

FR2: 24.25 GHz to 52.6 GHz

In FR1, Sub-Carrier Spacing (SCS) of 15 kHz, 30 kHz, or 60 kHz is used, and a bandwidth (BW) of 5 MHz to 100 MHz is used. FR2 is a higher frequency than FR1. Moreover, FR2 uses SCS of 60 kHz or 120 kHz (240 kHz may be included), and uses a bandwidth (BW) of 50 MHz to 400 MHz.

Note that SCS may be interpreted as numerology. The numerology is defined in 3GPP TS38.300 and corresponds to one subcarrier spacing in the frequency domain.

Furthermore, the radio communication system 10 can handle a frequency band that is higher than the frequency band of FR2. Specifically, the radio communication system 10 can handle a frequency band exceeding 52.6 GHz and up to 114.25 GHz. Here, such a high frequency band is referred to as “FR4” for convenience. FR4 belongs to so-called EHF (extremely high frequency, also called millimeter wave). FR4 is a temporary name and may be called by another name.

FR4 may be further classified. For example, FR4 may be divided into a frequency range of 70 GHz or less and a frequency range of 70 GHz or more. Alternatively, FR4 may be divided into more frequency ranges, and may be divided in frequencies other than 70 GHz.

Here, the frequency band between FR1 and FR2 is referred to as “FR3” for convenience. FR3 is a frequency band above 7.125 GHz and below 24.25 GHz.

In the present embodiment, FR3 and FR4 are different from the frequency band including FR1 and FR2, and may be called different frequency bands.

Particularly, as described above, in a high frequency band such as FR4, an increase in phase noise between carriers becomes a problem. This may require application of a larger (wider) SCS or a single carrier waveform.

In addition, since it is more sensitive to PAPR and power amplifier nonlinearity, a greater (wider) SCS (and/or fewer FFT points), a PAPR reduction mechanism, or a single carrier waveform may be required.

In the present embodiment, when a band exceeding 52.6 GHz is used, Cyclic Prefix-Orthogonal Frequency Division Multiplexing (CP-OFDM)/Discrete Fourier Transform-Spread (DFT-S-OFDM) having a larger Sub-Carrier Spacing (SCS) may be applied. The DFT-S-OFDM may be applied to not only an uplink (UL) but also a downlink (DL).

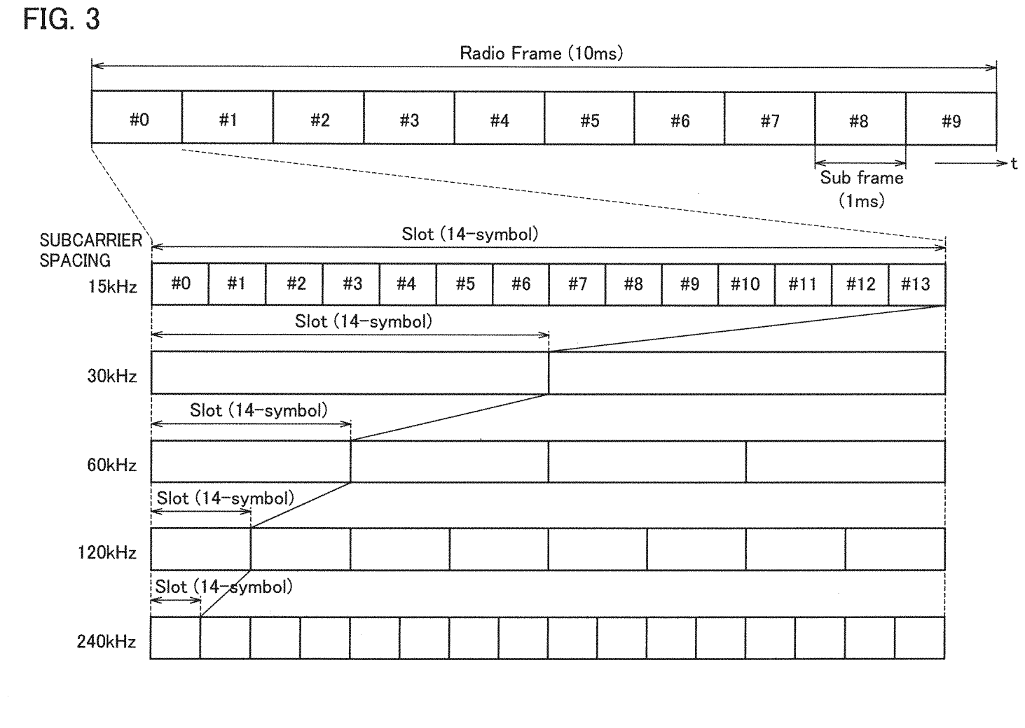

FIG. 3 illustrates a configuration example of a radio frame, subframes, and slots used in the radio communication system 10. Table 1 shows a relation between the SCS and the symbol period.

TABLE 1

| SCS | 15 kHz | 30 kHz | 60 kHz | 120 kHz | 240 kHz | 480 kHz | 950 kHz |
|---|---|---|---|---|---|---|---|
| Symbol Period | 66.6 | 33.3 | 16.65 | 8.325 | 4.1625 | 2.08125 | 1.040625 |
| (unit: μs) | | | | | | | |

As illustrated in FIG. 3 and Table 1, the symbol period (and the slot period) is shorter as the SCS is larger (wider). The period in a time domain of an SS/PBCH Block (SSB) is also shorter in the same manner.

When FR4 (a high frequency band) or the like is to be handled, a narrower beam needs to be generated using a massive antenna that has many antenna elements to address a wide bandwidth and large propagation loss. That is, many beams are required to cover a certain geographical area. For instance, in a case of an 80-GHz band, the propagation loss (path loss) is increased by about 9 dB as compared to a case of a 28-GHz band.

As a configuration example of the Massive MIMO, relative to an 8×8 configuration (the number of longitudinal antenna elements x the number of lateral antenna elements) for the 28-GHz band, a 24 (8×3)×24 (8×3) configuration (the number of longitudinal antenna elements x the number of lateral antenna elements) is cited as an example for the 80-GHz band, and the antenna gain is about +9.6 dB.

An SSB is a block of synchronization signal/broadcast channel, which is composed of SSs (Synchronization Signals) and a PBCH (Physical Broadcast CHannel). Principally, the SSBs are periodically transmitted to enable the UE 200 to detect cell IDs or reception timings at a start of communication. In the 5G, the SSBs are also used for measurement of reception quality of each cell.

In a case of Release 15, the followings are defined as setting of SSBs in a serving cell. Specifically, 5, 10, 20, 40, 80, and 160 milliseconds are defined as the transmission periodicity of SSBs. The transmission periodicity of 20 milliseconds is assumed for the UE 200 of initial accessing.

The network (the NG-RAN 20) notifies the UE 200 of index display (ssb-PositionsInBurst) of actually transmitted SSBs, by signaling of system information (SIB1) or a radio resource control layer (RRC).

Specifically, in a case of FR1, the notification is performed using an 8-bit bitmap of the RRC and the SIB1. In a case of FR2, the notification is performed using a 64-bit bitmap of the RRC, and an 8-bit bitmap of SSBs in a SIB1 group and an 8-bit group bitmap of the SIB1.

In a case of Release 15 (FR2), the maximum number of beams used for SSB transmission is 64. However, in order to cover a certain geographical area with narrow beams, it is preferable to expand the maximum number of beams (for example, to 256). In this case, the number of SSBs also becomes 256 and values larger than #64 are used as indices (SSB indices) to identify the SSBs.

An SSB is composed of synchronization signals (SSs) and a downlink physical broadcast channel (PBCH).

The SSs include a primary synchronization signal (PSS) and a secondary synchronization signal (SSS).

The PSS is a known signal that the UE 200 initially attempts to detect in a cell search procedure. The SSS is a known signal transmitted to detect a physical cell ID in the cell search procedure.

The PBCH includes information, such as a radio frame number (SFN: System Frame Number) and an index for identifying symbol positions of a plurality of SS/PBCH Blocks in a half frame (5 milliseconds), which is required by the UE 200 to establish frame synchronization with an NR cell formed by the gNB 100 after the SS/PBCH Blocks are detected.

The PBCH may also include a system parameter required to receive system information (SIB). An SSB also includes a broadcast channel demodulation reference signal (DMRS for PBCH). The DMRS for PBCH is a known signal transmitted to measure a radio channel state for PBCH demodulation.

The UE 200 assumes that the SSBs are respectively associated with beams BM having different transmission directions (coverages). Accordingly, the UE 200 located in an NR cell can receive any of the beams BM and acquire an SSB to start initial access and SSB detection/measurement.

The transmission patterns of the SSBs vary according to the SCS, the frequency range (FR), or other parameters. It is not always necessary to transmit all the SSBs. Only few SSBs may be selectively transmitted according to the network requirements, status, or the like, so that the UE 200 may be notified of SSBs that are transmitted and SSBs that are not transmitted.

The UE 200 is notified of the transmission patterns of the SSBs by an RRC IE (Information Element) called ssb-PositionsInBurst explained above.

The UE 200 is provided with transmission occasions (PRACH Occasions (ROs)) for one PRACH (Physical Random Access Channel, hereinafter, simply RACH as deemed appropriate) or a plurality of PRACHs associated with an SSB (SS/PBCH Block).

In the radio communication system 10, an SMTC window (SSB based RRM Measurement Timing Configuration window) is introduced as a function to notify, from its own cell, a terminal of the measurement periodicity of SSBs and the timings thereof used by the UE 200 (the terminal) for measurement. The SMTC window is a measurement window that is set by the gNB 100 to the terminal to enable SSBs to recognize the measurement start timing, the measurement period, and the measurement periodicity for each of measurement target cells when the terminal performs reception quality measurement using SSBs.

The periodicity of the SMTC windows is identical to that of SSBs and can be set, for example, in the range of 5, 10, 20, 40, 80, and 160 milliseconds. The width of the SMTC windows can be set to a value (for example, 1, 2, 3, 4, or 5 milliseconds) corresponding to the number of SSBs transmitted by a measurement target cell.

When notified of an SMTC window from the gNB 100, the terminal performs detection and measurement of SSBs in the SMTC window and reports the result to the gNB 100.

Further, a measurement gap (MG) is introduced in the radio communication system 10. Since measurement is perform using SSBs in the NR, the method for setting a measurement gap is optimized. In the NR, the periodicity of the SMTC windows and the window width can be flexibly set depending on SSB transmission. The measurement gap length (MGL) can be set to an appropriate value (for example, 6, 5.5, 4, 3.5, or 1.5 milliseconds) according to the SMTC window or the like.

For example, when the SMTC window is 2 milliseconds, 4 milliseconds can be set as the measurement gap. When the SMTC window is 4 milliseconds, 6 milliseconds longer than the SMTC window can be set as the measurement gap.

In the radio communication system 10, there is a possibility that the maximum number of beams is expanded and that the number of SSBs is also increased as explained above. Also in this case, the setting of the synchronization signal block (SSB), the SMTC window, and the measurement gap (MG) that enable avoidance of data scheduling delay is applied.

### (2) Functional Block Configuration of Radio Communication System

A functional block configuration of the radio communication system 10 is explained next. Specifically, a functional block configuration of the UE 200 is explained.

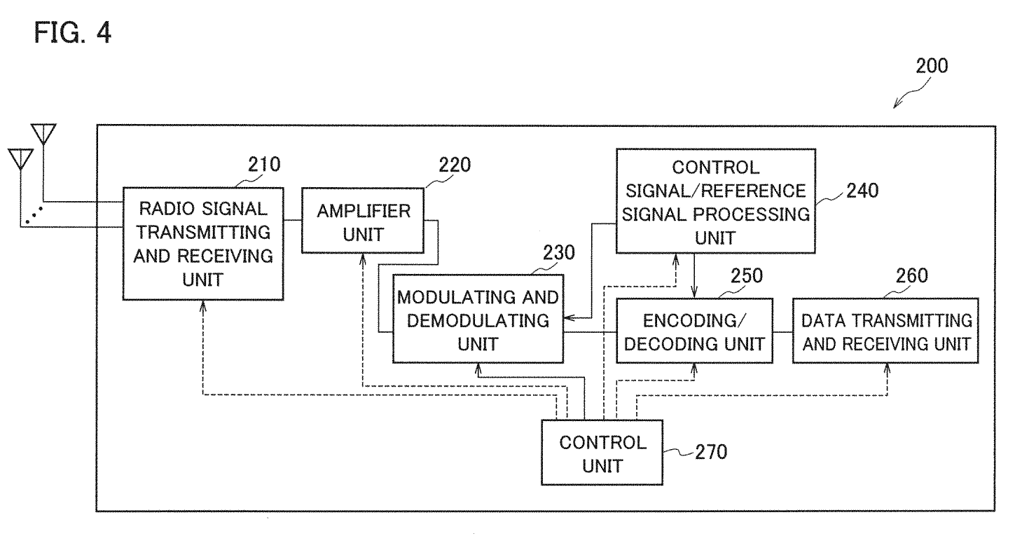

FIG. 4 is a functional block diagram of the UE 200. As illustrated in FIG. 4, the UE 200 includes a radio signal transmitting and receiving unit 210, an amplifier unit 220, a modulating and demodulating unit 230, a control signal/reference signal processing unit 240, an encoding/decoding unit 250, a data transmitting and receiving unit 260, and a control unit 270.

The radio signal transmitting and receiving unit 210 transmits and receives a radio signal according to the NR. The radio signal transmitting and receiving unit 210 corresponds to Massive MIMO, CA that bundles a plurality of CCs to use, DC in which communication is performed simultaneously between the UE and two NG-RAN Nodes, and the like.

In the present embodiment, the radio signal transmitting and receiving unit 210 can receive synchronization signal blocks, specifically, SSBs (SS/PBCH Blocks) in one frequency range or a plurality of frequency ranges, specifically, a frequency band including FR1 or FR2 and a different frequency band different from the frequency band, that is, FR3 or FR4. In the present embodiment, the radio signal transmitting and receiving unit 210 forms a receiving unit.

In the present embodiment, each SSB is divided into a plurality of synchronization signal groups (G_{SSB}s). That is, the G_{SSB}s divided from the SSB are separately arranged at different positions in the time direction.

Note that the time direction may also be called time domain, symbol period, symbol time, or the like. The symbol may also be called OFDM symbol.

The radio signal transmitting and receiving unit 210 can receive a relevant synchronization signal group transmitted according to a defined transmission periodicity, for example, a periodicity (P_{_SSB_G}) shorter than the transmission periodicity of the SSBs.

It suffices that the P_{_SSB_G} is shorter than the transmission periodicity of the SSBs and the unit of the P_{_SSB_G} may be a radio frame, a half frame, a subframe, or a slot (see FIG. 3).

The SMTC window includes the transmission positions of the SSBs in the time direction as explained above. However, in a case in which the SSBs are divided into G_{SSB}s, it is preferable that the SMTC window be expanded to include the G_{SSB}s.

Specifically, in a case in which one SSB is divided into a plurality of G_{SSB}s, the SMTC window is preferably expanded to include all the G_{SSB}s corresponding to the pre-divided SSB. However, it is adequate that the SMTC window includes some of the G_{SSB}s and the SMTC window does not always need to be expanded to include all the G_{SSB}s.

Further, the measurement gap is set to an appropriate value according to the SMTC window or the like as explained above. When an SSB is divided into G_{SSB}s, the measurement gap is preferably expanded to include the G_{SSB}s.

Specifically, in a case in which one SSB is divided into a plurality of G_{SSB}s, the measurement gap is preferably expanded to include all the G_{SSB}s and the SMTC window corresponding to the pre-divided SSB. However, it is adequate that the measurement gap includes some of the G_{SSB}s and the SMTC window, and the measurement gap does not always need to be expanded to include all the G_{SSB}s and the SMTC window.

In the present embodiment, on the basis of received SSBs, the radio signal transmitting and receiving unit 210 transmits Random Access Preamble in a PRACH Occasion (RO) associated with the received SSBs.

As explained above, a RO is an occasion for transmitting a preamble via a random access channel (PRACH). A random access (RA) procedure performed by the UE 200 may be a 4-step RA procedure (contention-based) or a 2-step RA procedure.

Specifically, in the contention-based RA procedure, transmission of Random Access Preamble, Random Access Response, Scheduled Transmission, and Contention Resolution is performed in this order. The Random Access Preamble, the Random Access Response, the Scheduled Transmission, and the Contention Resolution may be called Msg. 1, 2, 3, and 4, respectively. Note that the RA procedure may include a contention-free random access (CFRA) where a sequence is started by notification of allocation of Random Access Preamble to the UE 200 by the gNB 100.

In the 2-step RA procedure, transmission of Random Access Preamble and Random Access Response is performed in this order. The Random Access Preamble and the Random Access Response in the 2-step RA procedure may be called other names, respectively. Alternatively, the Random Access Preamble and the Random Access Response in the 2-step RA procedure may be called Msg. A and B, respectively.

The amplifier unit 220 is formed of a PA (Power Amplifier)/LNA (Low Noise Amplifier), or the like. The amplifier unit 220 amplifies a signal output from the modulating and demodulating unit 230 to a predetermined power level. The amplifier unit 220 also amplifies an RF signal output from the radio signal transmitting and receiving unit 210.

The modulating and demodulating unit 230 performs data modulation/demodulation, transmission power setting, resource block allocation, and the like, for each predetermined communication destination (the gNB 100 or other gNBs).

As explained above, the CP-OFDM and the DFT-S-OFDM are applicable in the present embodiment. Further, the DFT-S-OFDM can be used for the uplink (UL) and the downlink (DL) in the present embodiment.

The control signal/reference signal processing unit 240 executes processing relating to various control signals transmitted and received by the UE 200 and processing relating to various reference signals transmitted and received by the UE 200.

Specifically, the control signal/reference signal processing unit 240 receives various control signals transmitted via a predetermined control channel from the gNB 100, for example, a control signal for the radio resource control layer (RRC). The control signal/reference signal processing unit 240 also transmits various control signals to the gNB 100 via a predetermined control channel.

Moreover, the control signal/reference signal processing unit 240 executes processing by using reference signals (RS) such as Demodulation reference signal (DMRS) and Phase Tracking Reference Signal (PTRS).

DMRS is a known reference signal (pilot signal) for estimating a fading channel used for data demodulation between a base station specific for a terminal and the terminal. PTRS is a terminal-specific reference signal for the purpose of estimating phase noise which is an issue in the high frequency band.

The reference signal includes, apart from DMRS and PTRS, Channel State Information-Reference Signal (CSI-RS) and Sounding Reference Signal (SRS). Moreover, a channel includes a control channel and a data channel. A control channel includes PDCCH (Physical Downlink Control Channel), PUCCH (Physical Uplink Control Channel), RACH (Downlink Control Information (DCI) including Random Access Channel, Random Access Radio Network Temporary Identifier (RA-RNTI)), Physical Broadcast Channel (PBCH), and the like.

A data channel includes PDSCH (Physical Downlink Shared Channel), PUSCH (Physical Downlink Shared Channel), and the like. Data means data transmitted via a data channel.

The encoding/decoding unit 250 performs data division/connection, channel coding/decoding, and the like for each predetermined communication destination (the gNB 100 or other gNBs).

Specifically, the encoding/decoding unit 250 divides data output from the data transmitting and receiving unit 260 into data of a predetermined size and performs channel coding of the divided data. The encoding/decoding unit 250 decodes data output from the modulating and demodulating unit 230 and connects the decoded data to each other.

The data transmitting and receiving unit 260 transmits and receives Protocol Data Unit (PDU) and Service Data Unit (SDU). Specifically, the data transmitting and receiving unit 260 executes PDU/SDU assembly/disassembly and the like in multiple layers (such as a medium access control layer (MAC), a radio link control layer (RLC), and a packet data convergence protocol layer (PDCP)). The data transmitting and receiving unit 260 performs data error correction and retransmission control on the basis of a hybrid ARQ (Hybrid automatic repeat request).

The control unit 270 controls the functional blocks constituting the UE 200. Particularly, in the present embodiment, the control unit 270 controls receiving of SSBs by the radio signal transmitting and receiving unit 210, judging of a PRACH Occasion (RO) associated with the received SSBs, transmission of Random Access Preamble in the relevant RO, and the like.

The control unit 270 also executes control relating to reception quality measurement by the control signal/reference signal processing unit 240 on the basis of division of each of SSBs into a plurality of synchronization signal groups (G_{SSB}s), the lengths of the SMTC window and the measurement gap, and the like, controlled by the network (the gNB 100).

### (3) Operation of Radio Communication System

An operation of the radio communication system 10 is explained next. Specifically, examples of setting of the synchronization signal block (SSB), the SMTC window (hereinafter, SMTC), and the measurement gap (MG) are explained, and an operation of the UE 200 to receive SSBs and measure the reception quality according to the SMTC window and the measurement gap is also explained.

(3.1) Conventional example

To begin with, problems in a case in which the maximum number of SSBs exceeds 64 are explained with setting of the SSBs, the SMTC, and the MG of a conventional technique (3GPP Release 15) as an example. In the following explanations, it is assumed that the maximum number (L) of SSBs is 256.

(3.1.1) SSB

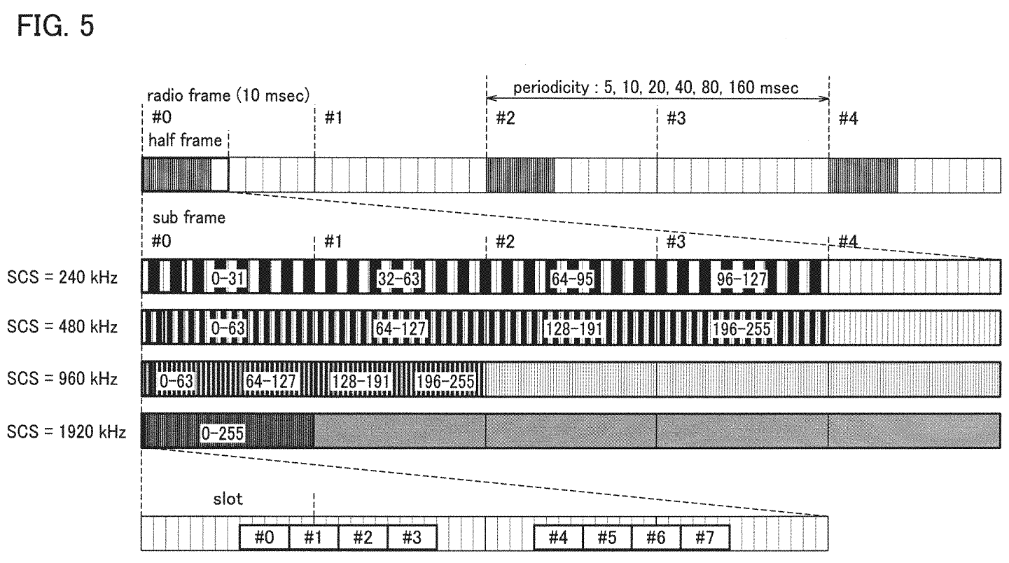

FIG. 5 illustrates a conventional setting example of SSBs. As illustrated in FIG. 5, SSBs having SSB indices 0 to 255 are arranged in a radio frame, specifically, a first half frame. As illustrated in FIG. 5, the slot (symbol) time is shorter as the SCS is larger. The lowermost drawing of FIG. 5 illustrates first four slots in the radio frame (subframe) in an enlarged manner and SSB #0 to #7 are arranged therein.

To support a case in which the number of SSBs >64, the SSBs are mapped into L_{_max}/2^{(μ+1)} subframes, where μ is SCS setting and L_{_max} is the number of SSBs in a half frame.

For example, when L_{_max}=256 and p=64 (SCS=480 kHz), the SSBs are mapped into four subframes (#0 to #3) and the uplink (UL) cannot be set in these subframes. That is, the UL can be set only in subframes #4 or later.

(3.1.2) RACH

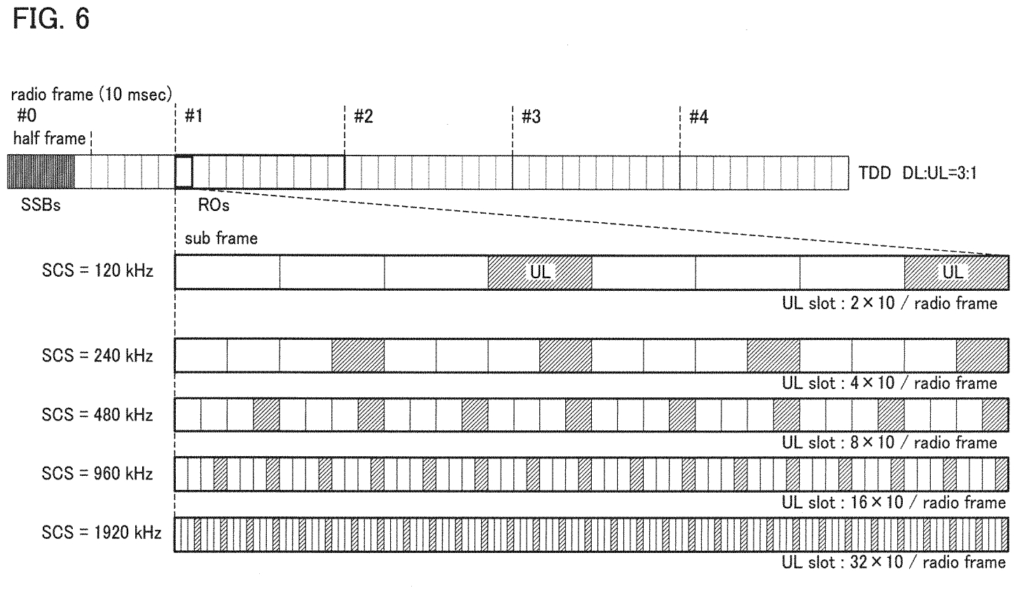

FIG. 6 illustrates a conventional setting example of RACH. When a status where the number of SSBs >64 is to be supported, many PRACH Occasions (ROs) are required.

For example, in a case in which time division duplex (TDD) is performed, the ratio between DL and UL has a relation DL:UL=3:1, and SCS=480 kHz, the number of UL slots (shaded parts) in a radio frame is 80 as illustrated in FIG. 6. Therefore, the number of ROs can be 480 (6 ROs/slot).

When the number of SSBs is 256, more than half of the UL slots in the radio frame are set to ROs and the overhead becomes too large.

(3.1.3) SSB and RACH

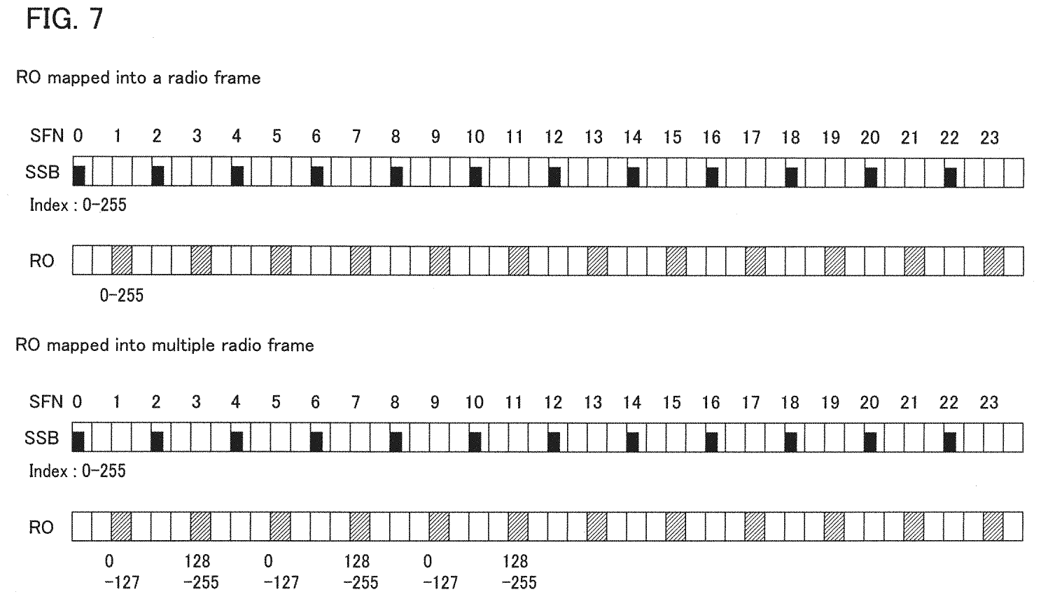

FIG. 7 illustrates a conventional setting example of SSBs and ROs. When many SSBs are to be supported, such as the case in which the number of SSBs >64, many ROs associated with the SSBs are also required as explained above.

In this case, it is considered that arrangement of ROs across a plurality of radio frames as illustrated in a lower drawing of FIG. 7 is also adequate.

However, a beam BM (see FIG. 1) most appropriate to the terminal has a narrow width of the beam BM and is highly likely to quickly vary due to some movement. Therefore, it is considered that SSBs associated with beams BM having different transmission directions (coverages) and ROs associated with the SSBs are desirably arranged to be close to each other in the time domain.

(3.2) Example

A setting example of SSBs and the like, that can avoid data scheduling delay even in a case in which the problems related to setting of SSBs and ROs (arrangement on a radio frame) explained above are resolved, a high frequency band such as FR4 is used, and SSBs more than 64 are supported is explained below.

In the following setting example, attention is paid to arrange SSBs and ROs close to each other in the time domain in consideration of the narrow width of beams BM.

(3.2.1) Outline

In the present example, as well as arrangement of SSBs on the radio frame, the lengths of the SMTC window (SMTC) and the measurement gap (MG) are controlled associated with the arrangement of SSBs.

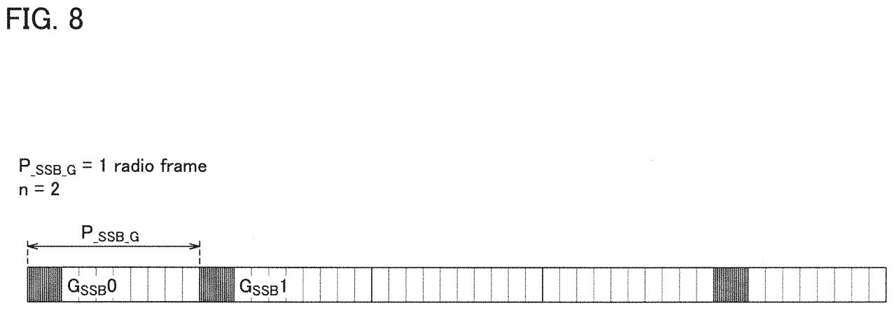

FIG. 8 illustrates a schematic image of arrangement of an SSB according to the present embodiment. As illustrated in FIG. 8, an SSB is divided into a plurality of synchronization signal groups (G_{SSB}0, G_{SSB}1, and the like).

Specifically, an SSB is divided into n synchronization signal groups and the synchronization signal groups are periodically allocated to the time domain ((n) radio frames/(n) half frames/(n) subframes/(n) slots). Parameters described in FIG. 8 will be explained later.

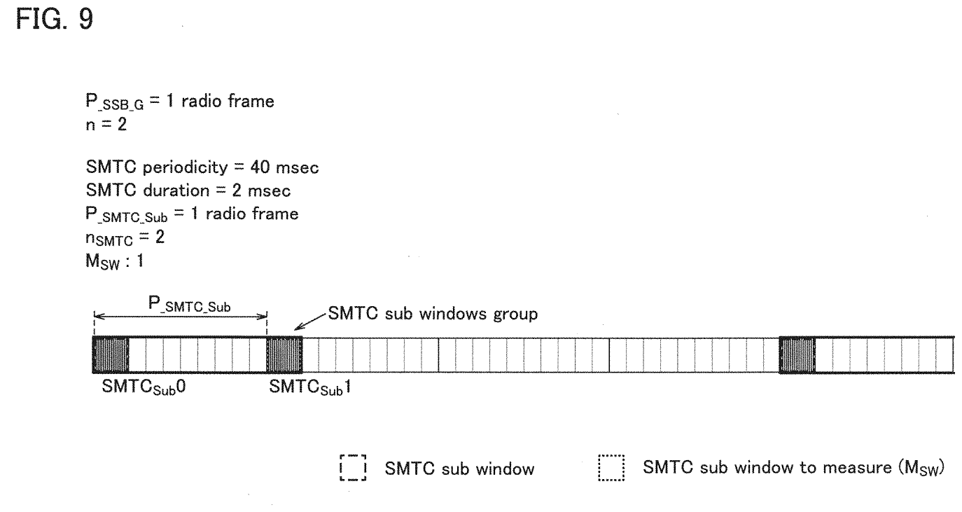

FIG. 9 illustrates a setting image of the SMTC according to the present embodiment. As illustrated in FIG. 9, the SMTC is expanded, that is, elongated in the length in the time direction to include the SSB divided into n synchronization signal groups.

For control of the length of the SMTC, “n_{SMTC}”, “P_{_SMTC_Sub}”, and “M_{SW}” are used. These parameters will be explained later.

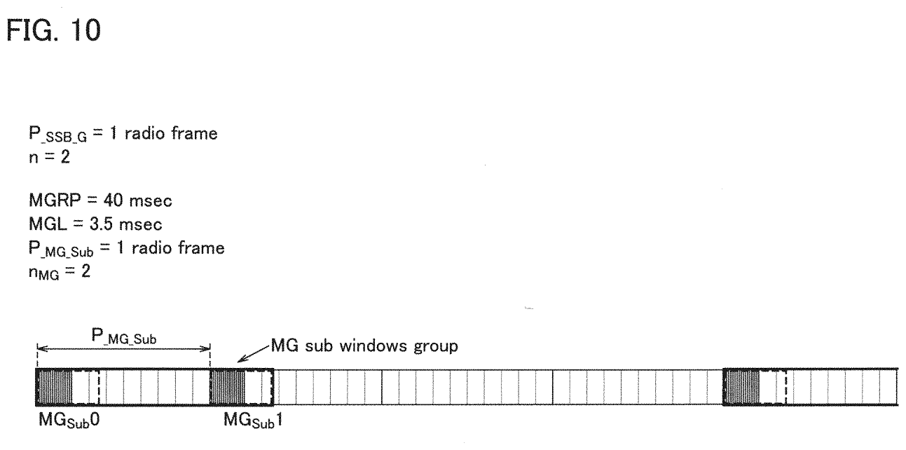

FIG. 10 illustrates a setting image of the MG according the present embodiment. As illustrated in FIG. 10, also the MG is expanded, that is, elongated in the length in the time direction to include the SSB divided into n synchronization signal groups.

For control of the length of the MG, “n_{MG}” and “P_{_MG_Sub}” are used. These parameters will be explained later.

(3.2.2) SSB

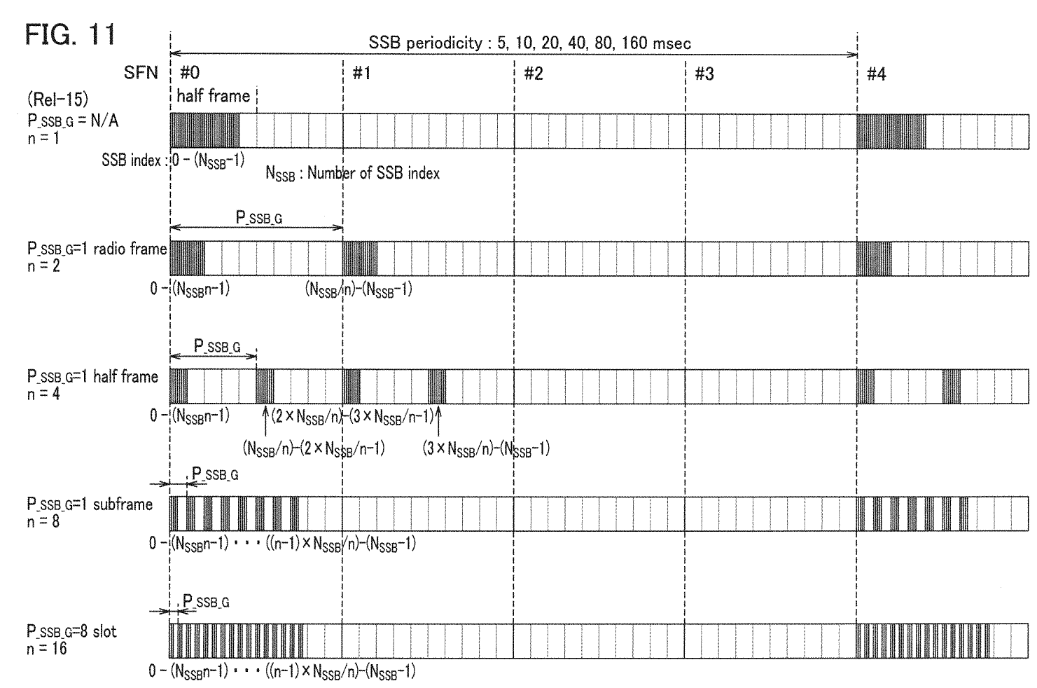

FIG. 11 illustrates a setting example of synchronization signal groups (G_{SSB}) according to the present embodiment. The topmost drawing of FIG. 11 illustrates a setting example of SSBs according to Release 15 for the purpose of comparison and the SSBs are not divided into a plurality of G_{SSB}s.

In the present example, n and P_{_SSB_G} are introduced.

An SSB is divided into “n” synchronization signal groups (shaded parts in FIG. 11), such as G_{SSB}0, G_{SSB}1, . . . , G_{SSB}n−1. A synchronization signal group (G_{SSB}) may be simply expressed as a group, an SSB group, or the like. Alternatively, it may be expressed as a sub SSB or a distributed SSB and the word “group” does not always need to be used.

That is, in a case in which a high frequency band such as FR4 is used and particularly the number of SSBs is more than 64, it is preferable that the SSBs be arranged in a distributed manner in the time domain relative to a case in which a frequency band such as FR1 or FR2 is used.

The G_{SSB}s are mapped into the time domain on the basis of the periodicity of P_{_SSB_G}s, such as (n) radio frames/(n) half frames/(n) subframes/(n) slots.

For example, in an example of the second drawing of FIG. 11, P_{_SSB_G}=1 (radio frame) and a G_{SSB} is arranged every radio frame. In an example of the fourth drawing of FIG. 11, P_{_SSB_G}=8 (slots) and a G_{SSB} is arranged every eight slots. N_{SSB} in FIG. 11 indicates the SSB index.

(3.2.3) SMTC

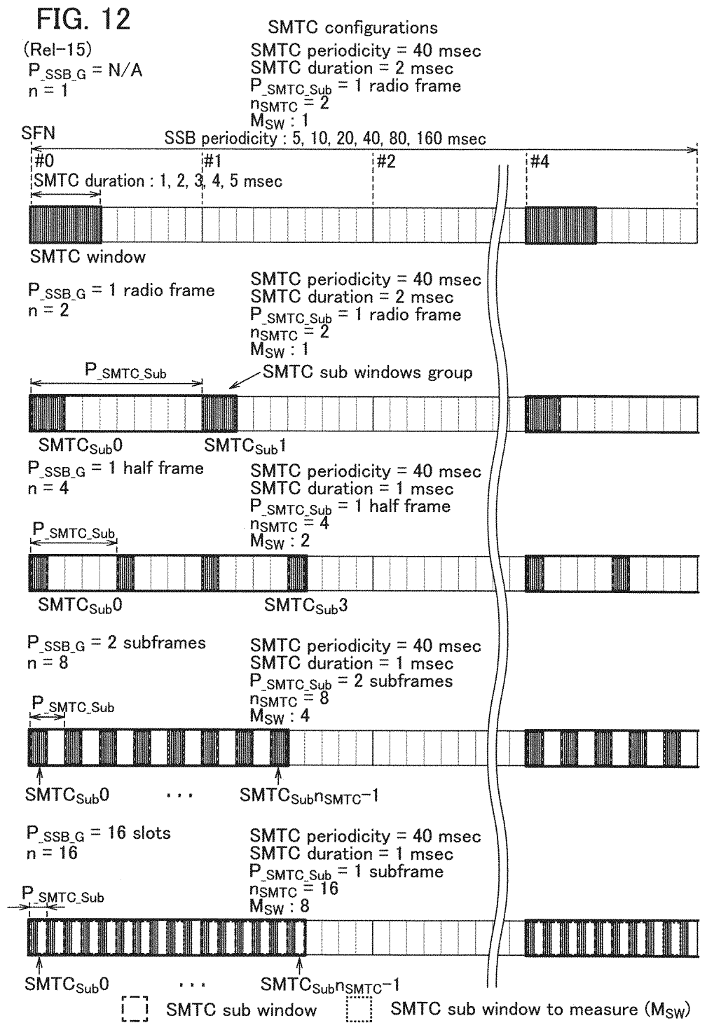

FIG. 12 illustrates a setting example of the SMTC according to the present embodiment. The topmost drawing of FIG. 12 illustrates a setting example of an SMTC according to Release 15 for the purpose of comparison.

In the present example, it is premised that an SSB is divided into G_{SSB}s, and the parameters n_{SMTC}, P_{_SMTC_Sub} and M_{SW} are introduced as explained above. For example, n_{SMTC} and P_{_SMTC_Sub} can be provided to the UE 200 (the terminal) by SIB or RRC layer signaling.

As illustrated in FIG. 12, the SMTC is divided into n_{SMTC} SMTC sub windows (dotted line frames in FIG. 12), such as SMTC_{Sub}0, SMTC_{Sub}1, . . . , SMTC_{Sub}n_{SMTC}−1.

An SMTC duration in FIG. 12 indicates the period (length) of the SMTC sub window. P_{_SMTC_sub} indicates the periodicity of the SMTC sub windows. An SMTC sub window group in FIG. 12 includes a plurality of SMTC sub windows and the periodicity of the SMTC sub window groups can be expressed as the SMTC periodicity.

Default values of n_{SMTC} and P_{_SMTC_Sub} are defined for initial access of the terminal. For example, (n_{SMTC}, P_{_SMTC_Sub})=(1, 0) is used. When the terminal does not recognize that the SSB is divided, (n_{SMTC}, P_{_SMTC_Sub})=(4, 0) may be typically applied.

When the terminal receives SSBs and temporarily selects a beam BM (an antenna beam), it is unnecessary to measure the SSBs using all SMTC sub windows. Accordingly, the terminal can designate SMTC sub windows as measurement targets using M_{SW}. Thin dotted line frames among the SMTC sub windows indicated by the dotted line frames in FIG. 12 indicate SMTC sub windows designated by M_{SW}.

M_{SW} may be designated by the terminal or may be designated by the network. Specifically, M_{SW} can be determined by any of the following options.
(option 1): the terminal determines M_{SW} (mainly for an idle mode)

Since the terminal has information of an antenna beam being in service (a serving antenna beam), the terminal determines M_{SW} including the serving antenna beam (that is, an SSB transmitted via the antenna beam).
(option 2): the network (the gNB 100) determines M_{SW} (mainly for a connection mode)

The network determines the serving antenna beam on the basis of feedback from the terminal and determines M_{SW} including the serving antenna beam on the basis of the determination. The terminal is notified of M_{SW}, for example, using a TCI (Transmission Configuration Indication) state, DCI (Downlink Control Information), or MAC-CE (Control Element).

When the network recognizes M_{SW} of the terminal, the network can stop transmission of SSBs not included in M_{SW} and can divert relevant resources to, for example, (user) data transmission.

However, detection and measurement of SSBs using all the SMTC sub windows are triggered in the following cases.

(i) Reference Signal Received Power (RSRP) of a serving antenna beam is smaller than a threshold A and RSRP of other beams using M_{SW} is smaller than a threshold B

(ii) RSRP of the serving antenna beam is smaller than a threshold C (<the threshold B)

(iii) detection of a beam failure (BF) or start of a T310 timer (for detection of a radio link failure (loss of synchronization)

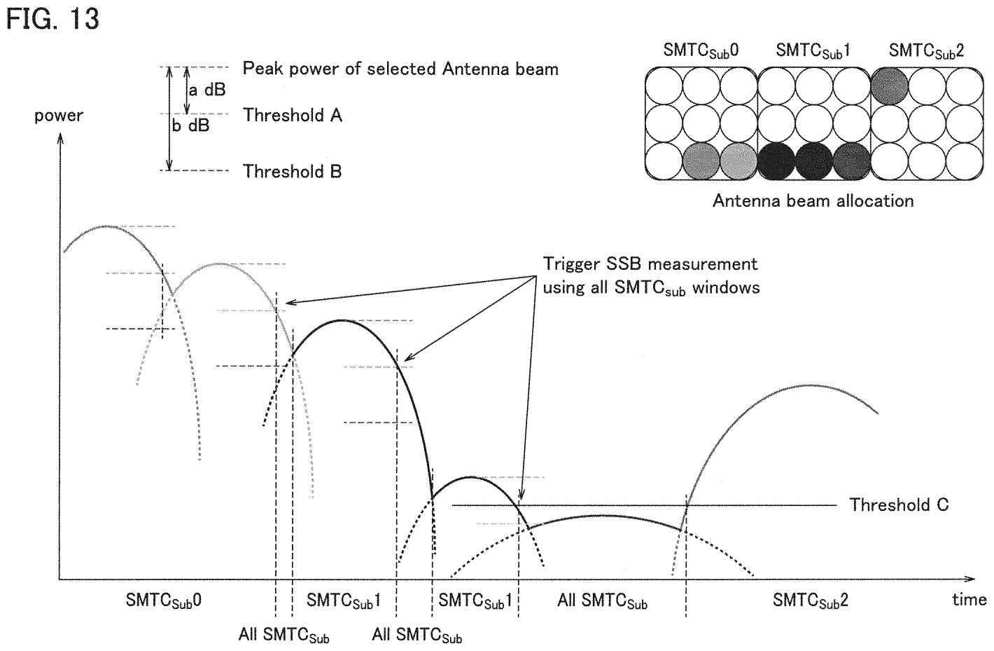

FIG. 13 illustrates an example of an antenna beam reception status in which SSB detection and measurement using all SMTC sub windows are triggered. As illustrated in FIG. 13, SSB detection and measurement using all SMTC sub windows are triggered when the condition (i) or (ii) explained above is met.

Scheduling limitation for intra-frequency measurement may be applied to SSBs in the SMTC sub windows (it is assumed that there is not one data symbol for transmitting and receiving data/signals before and after SSBs).

Note that scheduling limitation with two or more data symbols may be applied to detect a signal from a distant cell using an antenna beam with a narrow beam width, in consideration of a shorter symbol length/likelihood.

Any of the following options may be applied as a behavior of the terminal to SSB symbols in a deactivated SMTC sub window.
(option 1): when the network (the gNB 100) transmits data instead of SSBs, the terminal expects that data/signals can be transmitted or received in SSB symbols in the deactivated SMTC sub window
(option 2): since the network transmits SSBs irrespective of whether the terminal measures the SSBs, the terminal does not expect that data/signals can be transmitted or received in SSB symbols in the deactivated SMTC sub window.

(3.2.4) MG

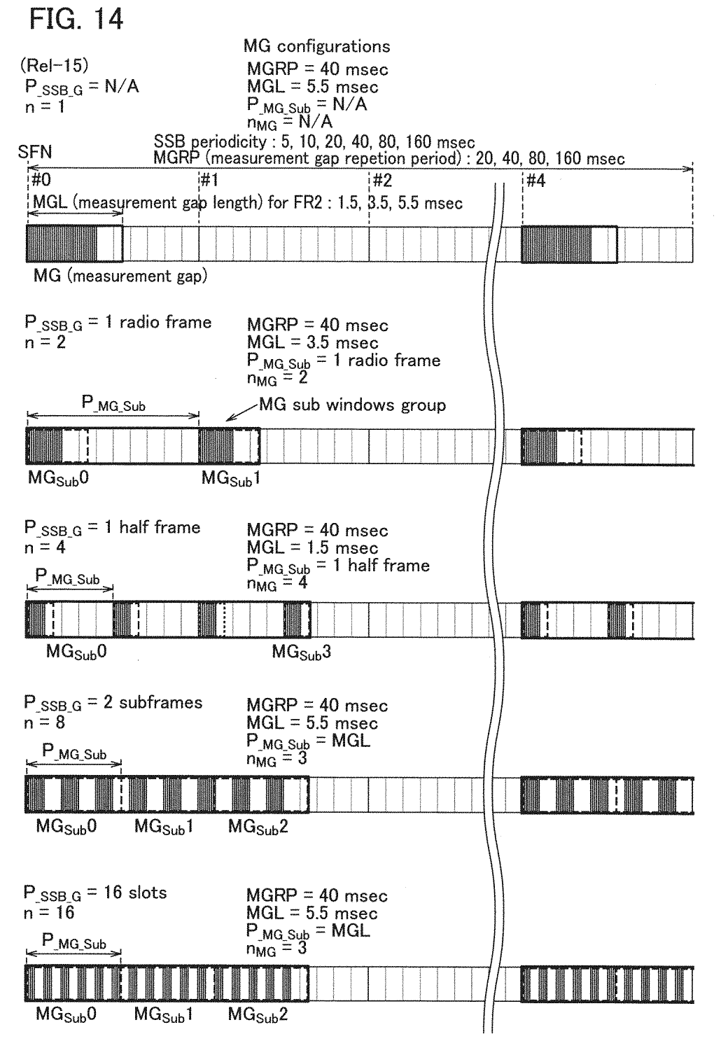

FIG. 14 illustrates a setting example of the MG according to the present example. The topmost drawing of FIG. 14 illustrates a setting example of the MG according to Release 15 for the purpose of comparison.

In the present embodiment, it is premised that an SSB is divided into G_{SSB}s and parameters n_{MG} and P_{_MG_Sub} are introduced as explained above. Accordingly, the length of the MG is also expanded.

As illustrated in FIG. 14, the MG is divided into n_{MG} MG sub windows (dotted line frames in FIG. 14), such as MG_{sub}0, MG_{sub}1, . . . , MG_{sub}n_{SMTC}−1.

An MGL (Measurement Gap Length) indicates the length (the time or the period) of the MG sub window. P_{_MG_Sub} indicates the periodicity of the MG sub windows. An MG sub window group in FIG. 14 includes a plurality of MG sub windows and the periodicity of the MG sub windows groups can be expressed as an MGRP (Measurement Gap Repetition Period).

The MGL for FR4 is defined in consideration of an RF returning time (for example, 0.5 millisecond (in a case of FR1) or 0.25 millisecond (in a case of FR2) before the MG or after the MG). The RF returning time is a switching time of the radio signal transmitting and receiving unit 210 (a radio unit).

Therefore, the MGL for FR4 can be shorter than 0.25 millisecond. When the UE 200 (the terminal) can support a dual receiver for FR4 as a target, any of the following options may be applied.
(option 1): FR4 and FR1/2/LTE-compatible dual receiver

Since the MG pattern for each FR is considered with respect to FR4 and FR1/FR2/LTE, this option influences only serving cells using FR4 in intra-frequency measurement using the MG.
(option 2): FR4 and FR1/LTE-compatible dual receiver

The MG pattern for each FR is considered with respect to FR4 and FR1/LTE, and the MG setting pattern for each terminal is considered with respect to FR4 and FR2. Therefore, this option influences only serving cells using FR4/FR2 in intra-frequency measurement using the MG.

### (4) Advantageous Effects

According to the abovementioned embodiment, the following effects can be achieved. Specifically, each SSB is divided into a plurality of synchronous signal groups (G_{SSB}s) in the present embodiment. That is, the G_{SSB}s divided from the SSB are separately arranged at different positions in the time direction.

Therefore, even when SSBs are expanded to a number exceeding 64, many SSBs are not arranged continuously in the time domain and delay of data scheduling to the terminal can be avoided. That is, according to the radio communication system 10, even when a different frequency band different from FR1/FR2, such as FR4 is used and the number of SSBs is expanded, data scheduling delay can be avoided.

In the present embodiment, along with division of the SSB into G_{SSB}s, the SMTC and the MG are also expanded to include the G_{SSB}s. Therefore, even when each SSB is divided into G_{SSB}s, the UE 200 can measure the reception quality using appropriate SMTC and MG.

### (5) Other Embodiments

Although the contents of the present invention have been described by way of the embodiments, it is obvious to those skilled in the art that the present invention is not limited to what is written here and that various modifications and improvements thereof are possible.

For instance, in the abovementioned embodiment, the description was made with a high frequency band such as FR4, that is, a frequency band exceeding 52.6 GHz as an example. However, at least any of the operation examples explained above may be applied to other frequency ranges such as FR3.

Furthermore, as explained above, FR4 may be divided into a frequency range of 70 GHz and lower and a frequency range of 70 GHz and higher. The correspondence between the division of each SSB into a plurality of G_{SSB}S and the frequency range may be changed, for example, the abovementioned division of each SSB into G_{SSB}s is applied to the frequency range of 70 GHz and higher, as deemed appropriate.

Moreover, the block diagram used for explaining the embodiments (FIG. 4) shows blocks of functional unit. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that causes transmitting may be called a transmitting unit or a transmitter. For any of the above, as explained above, the realization method is not particularly limited to any one method.

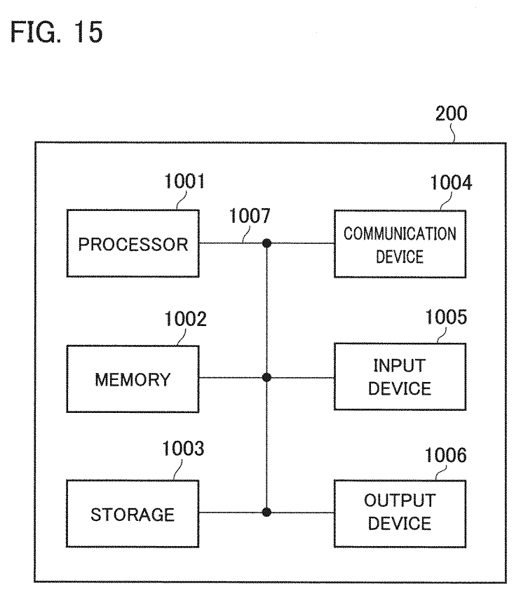

Furthermore, the UE 200 explained above can function as a computer that performs the processing of the radio communication method of the present disclosure. FIG. 15 is a diagram illustrating an example of a hardware configuration of the UE 200. As shown in FIG. 15, the UE 200 can be configured as a computer device including a processor 1001, a memory 1002, a storage 1003, a communication device 1004, an input device 1005, an output device 1006, a bus 1007, and the like.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

The functional blocks of the UE 200 (see FIG. 4) can be realized by any of hardware elements of the computer device or a desired combination of the hardware elements.

Moreover, the processor 1001 performs computing by loading a predetermined software (computer program) on hardware such as the processor 1001 and the memory 1002, and realizes various functions of the UE 200 by controlling communication via the communication device 1004, and controlling reading and/or writing of data on the memory 1002 and the storage 1003.

The processor 1001, for example, operates an operating system to control the entire computer. The processor 1001 can be configured with a central processing unit (CPU) including an interface with a peripheral device, a control device, a computing device, a register, and the like.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 can be called register, cache, main memory (main memory), and the like. The memory 1002 can store therein a computer program (computer program codes), software modules, and the like that can execute the method according to the embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

In addition, the respective devices, such as the processor 1001 and the memory 1002, are connected to each other with the bus 1007 for communicating information there among. The bus 1007 can be constituted by a single bus or can be constituted by separate buses between the devices.

Further, the device is configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Notification of information is not limited to that explained in the above aspect/embodiment, and may be performed by using a different method. For example, the notification of information may be performed by physical layer signaling (for example, Downlink Control Information (DCI), Uplink Control Information (UCI), upper layer signaling (for example, RRC signaling, Medium Access Control (MAC) signaling, notification information (Master Information Block (MIB), System Information Block (SIB)), other signals, or a combination of these. The RRC signaling may be called RRC message, for example, or can be RRC Connection Setup message, RRC Connection Reconfiguration message, or the like.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

As long as there is no inconsistency, the order of processing procedures, sequences, flowcharts, and the like of each of the above aspects/embodiments in the present disclosure may be exchanged. For example, the various steps and the sequence of the steps of the methods explained above are exemplary and are not limited to the specific order mentioned above.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from an upper layer (or lower layer) to a lower layer (or upper layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each aspect/embodiment described in the present disclosure may be used separately or in combination, or may be switched in accordance with the execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of a channel and a symbol may be a signal (signaling). Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS)”, “user terminal”, “user equipment (User Equipment: UE)”, “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The moving body may be a vehicle (for example, a car, an airplane, or the like), a moving body that moves unmanned (for example, a drone, an automatically driven vehicle, or the like), a robot (manned type or unmanned type) At least one of a base station and a mobile station can be a device that does not necessarily move during the communication operation. For example, at least one of a base station and a mobile station may be an Internet of Things (IoT) device such as a sensor.

Also, a base station in the present disclosure may be read as a mobile station (user terminal, hereinafter the same). For example, each of the aspects/embodiments of the present disclosure may be applied to a configuration that allows a communication between a base station and a mobile station to be replaced with a communication between a plurality of mobile stations (for example, may be referred to as Device-to-Device (D2D), Vehicle-to-Everything (V2X), or the like). In this case, the mobile station may have the function of the base station. Words such as “uplink” and “downlink” may also be replaced with wording corresponding to inter-terminal communication (for example, “side”). For example, terms an uplink channel, a downlink channel, or the like may be read as a side channel.

Likewise, a mobile station in the present disclosure may be read as a base station. In this case, the base station may have the function of the mobile station. A radio frame may be composed of one or more frames in the time domain. Each frame or frames in the time domain may be referred to as a subframe.

A subframe may be further configured by one or more slots in the time domain. The subframe may have a fixed time length (e.g., 1 ms) that does not depend on the numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in a time unit larger than a minislot may be referred to as PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one between a subframe and TTI may be a subframe (1 ms) in existing LTE, or may be shorter than 1 ms (for example, 1 to 13 symbols), or a period longer than 1 ms. Note that, a unit representing TTI may be called a slot, a minislot, or the like instead of a subframe.

Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. Further, the number of slots (the number of minislots) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the numerology. The number of subcarriers included in the RB may be determined based on the numerology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (Bandwidth Part: BWP) (which may be called a partial bandwidth, etc.) may represent a subset of contiguous common resource blocks (RBs) for a certain numerology in a certain carrier. Here, a common RB may be specified by RB index based on the common reference point of the carrier. PRB may be defined in BWP and numbered within that BWP.

BWP may include UL BWP (UL BWP) and DL BWP (DL BWP). One or a plurality of BWPs may be set in one carrier for the UE.

At least one of the configured BWPs may be active, and the UE may not expect to send and receive certain signals/channels outside the active BWP. Note that “cell”, “carrier”, and the like in this disclosure may be read as “BWP”.

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access”. In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on”.

The “means” in the configuration of each apparatus may be replaced with “unit”, “circuit”, “device”, and the like.

Any reference to an element using a designation such as “first”, “second”, and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining” and “determining” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. In other words, “judgement” and “decision” may include considering some operation as “judged” and “decided”. Moreover, “judgment (decision)” may be read as “assuming”, “expecting”, “considering”, and the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 Radio communication system
20 NG-RAN
100 gNB
200 UE
210 Radio signal transmitting and receiving unit
220 Amplifier unit
230 Modulating and demodulating unit
240 Control signal/reference signal processing unit
250 Encoding/decoding unit
260 Data transmitting and receiving unit
270 Control unit
1001 Processor
1002 Memory
1003 Storage
1004 Communication device
1005 Input device
1006 Output device
1007 Bus

1. A terminal comprising:
a receiving unit that receives a plurality of synchronization signal blocks in a frequency band including one frequency range or a plurality of frequency ranges and a different frequency band different from the frequency band, wherein
the synchronization signal blocks are divided into a plurality of synchronization signal groups, and
the receiving unit receives the synchronization signal groups transmitted according to a periodicity shorter than a defined transmission periodicity.

2. The terminal according to claim 1, wherein a measurement window including a transmission position of each of the synchronization signal blocks in a time direction is expanded to include the plurality of synchronization signal groups.

3. The terminal according claim 1, wherein a measurement gap including a transmission position of each of the synchronization signal blocks in a time direction is expanded to include the plurality of synchronization signal groups.
